(19) United States
(12) Patent Application Publication
(10) Pub. No.: US 2014/0047047 A1
(43) Pub. Date: Feb. 13, 2014

(54) MAIL TRANSIT SYSTEM AND MAIL RECYCLING CORRECTION METHOD THEREOF

(71) Applicants: INVENTEC APPLIANCES (PUDONG) CORPORATION, Shanghai (CN); INVENTEC APPLIANCES (SHANGHAI) CO., LTD., Shanghai City (CN); INVENTEC APPLIANCES (NANCHANG) CORPORATION, Nanchang (CN); INVENTEC APPLIANCES CORP., New Taipei City (TW)

(72) Inventors: Ju-Nan CHANG, Nanchang (CN); Qing WU, Nanchang (CN); Chang-Tao WANG, Nanchang (CN)

(73) Assignees: INVENTEC APPLIANCES (PUDONG) CORPORATION, Shanghai (CN); INVENTEC APPLIANCES (SHANGHAI) CO., LTD., Shanghai City (CN); INVENTEC APPLIANCES (NANCHANG) CORPORATION, Nanchang (CN); INVENTEC APPLIANCES CORP., New Taipei City (TW)

(21) Appl. No.: 13/950,035

(22) Filed: Jul. 24, 2013

(30) Foreign Application Priority Data
Aug. 9, 2012 (CN) 201210282646.4

(51) Int. Cl. H04L 12/58

(52) U.S. Cl. CPC H04L 51/28
USPC 709/206

(57) ABSTRACT

Disclosed are a mail transit system and a mail recycling correction method. The mail transit system includes a sending-end device and a cloud transit device. The sending-end device is configured to provide a user to send a mail message via a first mail box interface. The cloud transit device is connected to the sending-end device, and configured to receive the mail message, perform address transformation, and transmit the transformed mail message to a second mail box interface. The first mail box interface is different from the second mail box interface, and when the mail message in the second mail box interface is in an unread state, the sending-end device is provided for the user to amend the mail message and send a correction command to the cloud transit device, so as to recycle or amend the mail message at the second mail box interface by the cloud transit device.

### CROSS-REFERENCE TO RELATED APPLICATION

This application claims the benefit of China Patent Application No. 201210282646.4, filed on Aug. 9, 2012, in the State Intellectual Property Office of the People's Republic of China, the disclosure of which is incorporated herein in its entirety by reference.

### BACKGROUND OF THE INVENTION

1. Field of the Invention

The present invention relates to a mail transit system and a mail recycling correction method thereof, and more particularly to the mail transit system and the mail recycling correction method thereof capable of recycling or correcting a mail in an unread state between different mail box interfaces.

2. Description of the Related Art

As information technology advances, people tend to utilize networks for communications and information transmissions when large differences in time and space are involved. In numerous network services, email has become one commonly used service functions, and thus many network browsers start to introduce the service of email systems to meet user's requirements for the network browsers.

The purpose of using emails nowadays is simply to avoid the traveling distance and time involved in using physical mails. Since the application of email becomes more popular, convenient, and quicker, users generally do not double check their mails before sending them. However, if an email is found to be sent to a wrong recipient, or the sender forgets to attach a file, or it is necessary to add supplement to the content of the mail, then the mail has to be edited or rewritten, which not only wastes time on editing the mail, attaching the file, or adding the correct recipient, but also incurs a burden to the server and increases the labor cost. If a confidential mail is sent to a wrong recipient, unexpected risks may be incurred.

In present application programs, an email system is provided for users to recycle a wrongly sent email if the users sent the email by mistake. However, in cases where a user had sent an email between different mail box interfaces and found that the recipient was wrong or it is necessary to amend the content of the mail, the recycling function of the mail box that sends out the mail is lost, and thus it becomes necessary to rewrite another mail. In addition, there is a risk of leaking the confidential information of an important document attached in the mail. Therefore, it is an important and urgent subject for related manufacturers or designers to provide a mail system capable of recycling a mail transmitted between two different mail boxes and amending the mail in order to prevent the server from being overloaded or avoid unnecessary waste of time and labor.

### SUMMARY OF THE INVENTION

In view of the aforementioned problems of the prior art, it is a primary objective of the present invention to provide a mail transit system and a mail recycling correction method thereof to overcome the problems of the prior art that is unable to recycle or amend a mail between two different mail box interfaces.

To achieve the aforementioned objective, the present invention provides a mail transit system comprising a sending-end device and a cloud transit device. The sending-end device is configured to provide a user to send a mail message via a first mail box interface. The cloud transit device can be connected to the sending-end device for receiving the mail message and performing an address transformation, and further transmitting the transformed mail message to a second mail box interface, wherein the first mail box interface is different from the second mail box interface. When the mail message in the second mail box interface is in an unread state, the sending-end device is configured to provide the user to amend the mail message and send a correction command to the cloud transit device, so as to recycle or amend the mail message at the second mail box interface by the cloud transit device.

Preferably, the cloud transit device includes a transformation program for transforming the mail message.

Preferably, the cloud transit device includes a storing module for storing the transformation program.

Preferably, the cloud transit device includes a transmitting module for receiving and transmitting the mail message between the first mail box interface and the second mail box interface.

Preferably, the sending-end device includes a temporary storage module storing the mail message so as to provide the user to select the mail message stored in the temporary storage module to perform a correction process.

To achieve the aforementioned objective, the present invention further provides a mail recycling correction method comprising the steps of utilizing a sending-end device to provide a user to send a mail message via a first mail box interface; receiving the mail message and transforming an address of the mail message by a cloud transit device; utilizing the cloud transit device to transmit the transformed mail message to a second mail box interface, wherein the first mail box interface is different from the second mail box interface; utilizing the sending-end device to provide the user to amend the mail message and send a correction command to the cloud transit device when the mail message in the second mail box interface is in an unread state; and recycling or amending the mail message at the second mail box interface by the cloud transit device.

Preferably, the cloud transit device includes a transformation program for performing the step of transforming the address of the mail message.

Preferably, this method further comprises the step of storing the transformation program by a storing module of the cloud transit device.

Preferably, the cloud transit device receives or transmits the mail message between the first mail box interface and the second mail box interface by a transmitting module.

Preferably, this method further comprises the step of utilizing a temporary storage module of the sending-end device to store the mail message so as to provide the user to select the mail message stored in the temporary storage module to perform a correction process.

In summation, the mail transit system and the mail recycling correction method of the present invention have one or more of the following advantages:

(1) The mail transit system and the mail recycling correction method can recycle mail messages transmitted between different mail box interfaces and amend the content and the list of recipients of the mail message, after which the amended mail message can be resent. In addition, the original mail message is deleted to prevent sending the mail message repeatedly and avoid the overloading of the server.

(2) The mail transit system and the mail recycling correction method can recycle a wrongly sent mail message and allow the senders to correct the recipients or attached files of the mail message before the recipients open the wrongly sent mail message, so as to maintain the confidentiality of confidential documents or avoid risks incurred by the leakage of those documents.

### BRIEF DESCRIPTION OF THE DRAWINGS

FIG. 1 is a block diagram of a mail transit system of a preferred embodiment of the present invention.

FIG. 2 is a schematic view of a mail transit system of a preferred embodiment of the present invention.

FIG. 3 is a flow chart of a mail recycling correction method of a preferred embodiment of the present invention.

### DETAILED DESCRIPTION OF THE PREFERRED EMBODIMENTS

The technical characteristics, contents, advantages and effects of the present invention will become apparent with the detailed description of the following embodiments and the illustration of related drawings as follows. All figures are drawn for ease of explanation of the basic teachings of the present invention only. The disclosed embodiments may be modified in various ways. The present invention is not limited to the disclosed embodiments. Rather, it covers all modifications, equivalents and substitutes to the disclosed embodiments. It is noteworthy that same numerals are used to represent respective same elements in the following preferred embodiments.

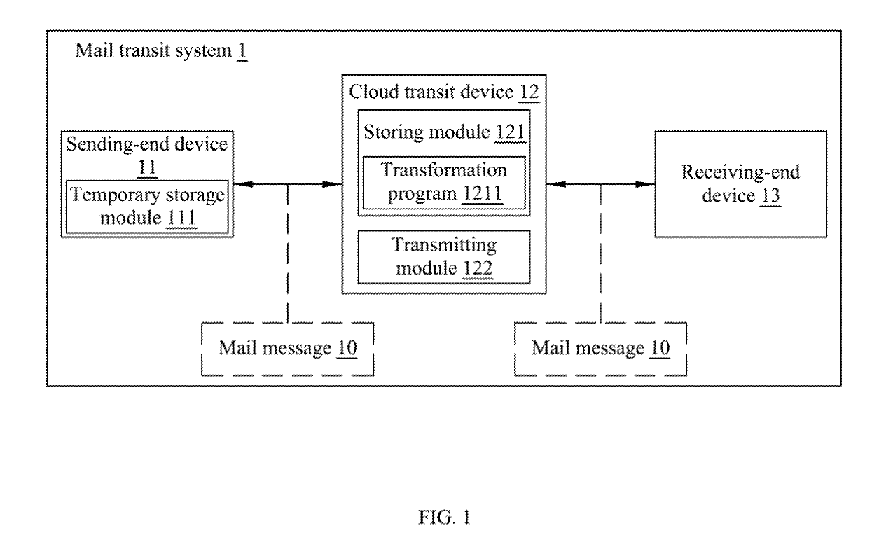

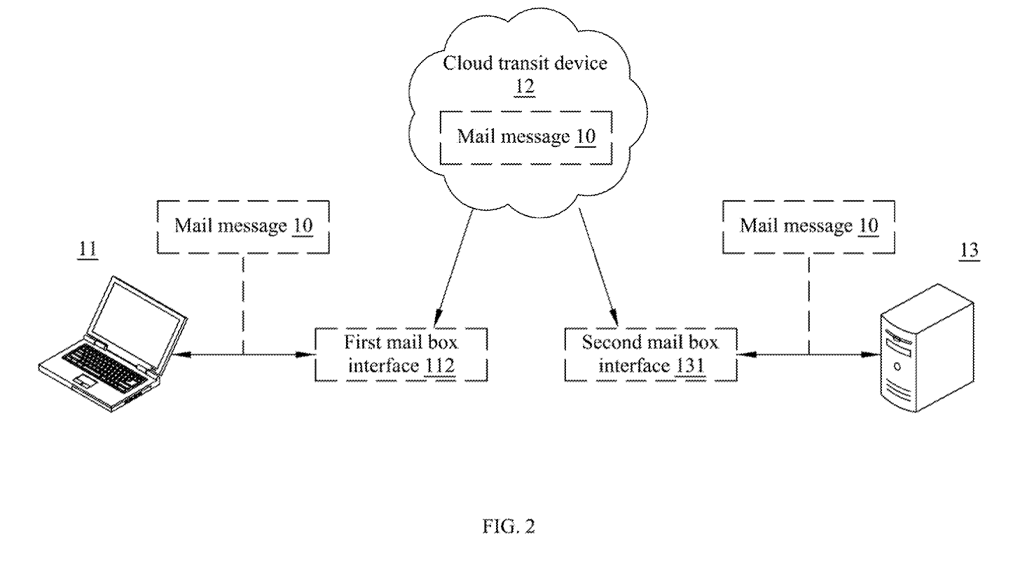

With reference to FIGS. 1 and 2 for a block diagram and a schematic view of a mail transit system in accordance with a preferred embodiment of the present invention, the mail transit system 1 comprises a sending-end device 11, a cloud transit device 12 and a receiving-end device 13. The sending-end device 11 can be connected to the cloud transit device 12, and the cloud transit device 12 can be connected to the receiving-end device 13. The cloud transit device 12 comprises a storing module 121 and a transmitting module 122. The storing module 121 has a transformation program 1211 stored therein. The sending-end device 11 and the receiving-end device 13 can be electronic devices including but not limited to personal computers, notebook computers, Smartphones, tablet PCs, or personal digital assistants (PDAs). The cloud transit device 12 can be a network server, but the invention is not limited to such arrangement only.

The sending-end device 11 can send a mail message 10 through a first mail box interface 112 of a network mail system. After the mail transit device 12 received the mail message 10 from the first mail box interface 112, the transformation program 1211 in the storing module 121 transforms the address of the mail message 10 which is further transmitted by the transmitting module 122 to a second mail box interface 131. If the mail message 10 in the second mail box interface 131 is in an unread state, the sending-end device 11 can select the mail message 10 from a temporary storage module 111 and send out a correction command to recycle the mail message 10 from the second mail box interface 131 through the transmitting module 122 of the cloud transit device 12, and transmit the recycled mail message 10 to the first mail box interface 112 for a user to correct the mail message 10 in the temporary storage module 111. After the mail message 10 is amended, the mail message 10 can be resent, and the mail message 10 stored in the temporary storage module 111 before the amendment will be deleted to reduce the burden of the network mail system.

For example, after a sender had sent a mail message 10 and found that the mail message 10 had been sent to a wrong recipient, or the content of the mail message 10 requires amendment, or a required file had not been attached, the sender can select the mail message 10 in the temporary storage module 111 of the sending-end device 11 to send a correction command to the cloud transit device 12. If the mail message 10 in the receiving-end device 13 is in an unread state, then the mail message 10 in the second mail box interface 131 can be recycled through the transmitting module 122, and further transmitted to the first mail box interface 112 for the user to amend the mail message. In cases where the mail message 10 was sent to a wrong recipient, the sender can recycle the mail message 10 and then add or delete the recipient in the recipient list. If the mail message 10 had been sent to three recipients A, B, and C before the amendment was made and it was found that the mail message 10 had been sent to the recipient A by mistake, then the mail message 10 can be recycled and the recipient A can be deleted from the recipient list, and then the amended mail message 10 is resent to the two recipients B and C. If the mail message 10 sent includes a plurality of contents D, E, and F, and it is found that the correct contents of the mail message 10 sent should be D and F, the contents of the mail message 10 can be amended and the content E is deleted from the contents of the original mail message 10, after which the correct amended mail message 10 is resent. After the mail message 10 is resent, the temporary storage module 111 deletes the original mail message 10 to reduce the burden of the network mail system.

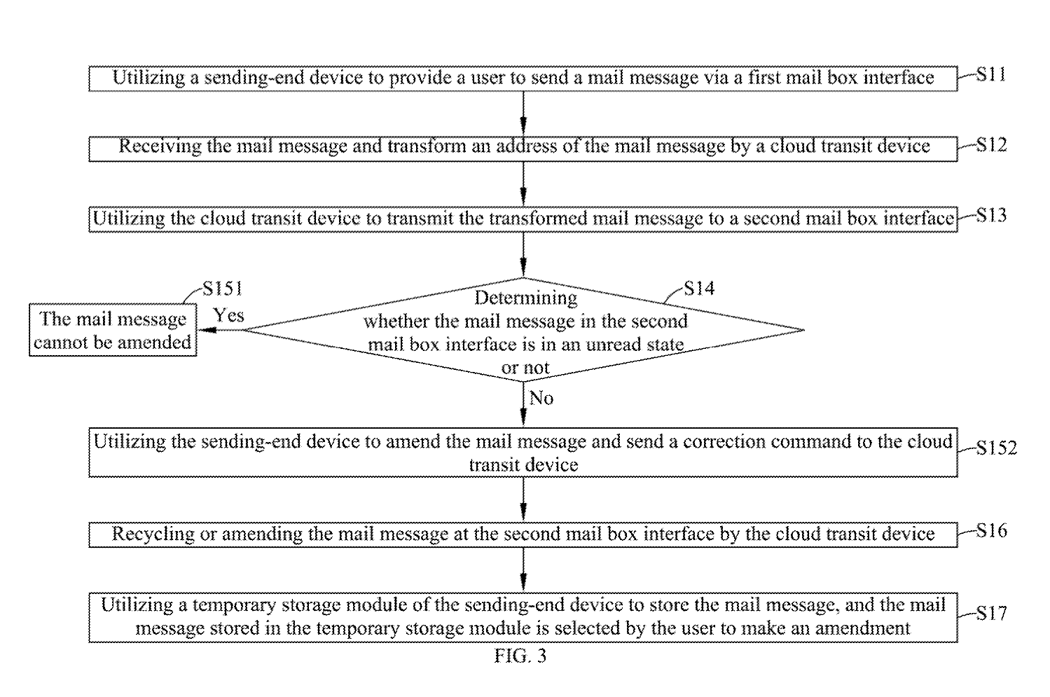

With reference to FIG. 3 for a flow chart of a mail recycling correction method in accordance with a preferred embodiment of the present invention, the mail recycling correction method comprises the following steps:

S11: Utilizing a sending-end device to provide a user to send a mail message via a first mail box interface. Wherein, the sending-end device can be a device including but not limited to a personal computer, a notebook computer, a tablet PC, a Smartphone, or a personal digital assistant (PDA) that is capable of connecting to the Internet.

S12: Receiving the mail message and transforming an address of the mail message by a cloud transit device.

S13: Utilizing the cloud transit device to transmit the transformed mail message to a second mail box interface. Wherein, the first mail box interface is different from the second mail box interface.

S14: Determining whether the mail message in the second mail box is in an unread state or not, and whether the user wants to amend the content or the recipients of the mail message.

S151: The mail message cannot be amended if the mail message in the receiving-end device is not in an unread state.

S152: Utilizing the sending-end device to amend the mail message and send a correction command to the cloud transit device if the mail message is in an unread state.

S16: Recycling or amending the mail message at the second mail box interface by the cloud transit device.

S17: Utilizing a temporary storage module of the sending-end device to store the mail message, wherein the mail message stored in the temporary storage module is selected by the user to make an amendment.

In summation of the description above, the mail transit system and the mail recycling correction method of the present invention transforms the address of a mail message by the cloud transit device. If the sender wants to amend the contents of the mail message, the sender can use the transmitting device to recycle the mail message from the second mail box interface and transmit the recycled mail to the first mail box interface, so that the temporary storage module of the sending-end device can resend the mail message after the necessary amendment is made. In the meantime, the original mail message can be deleted. Therefore, the invention can avoid the problem of writing a new mail and prevent the network mail system from being overloaded.

While the invention has been described by means of specific embodiments, numerous modifications and variations could be made thereto by those skilled in the art without departing from the scope and spirit of the invention set forth in the claims as follows.

What is claimed is:

1. A mail transit system, comprising:
a sending-end device, configured to provide a user to send a mail message via a first mail box interface; and
a cloud transit device connecting the sending-end device, and being configured to receive the mail message and perform an address transformation and transmit a transformed mail message to a second mail box interface;
wherein, the first mail box interface is different from the second mail box interface, and when the mail message in the second mail box interface is in an unread state, the sending-end device provides the user to amend the mail message and sends a correction command to the cloud transit device, so as to recycle or amend the mail message at the second mail box interface by the cloud transit device.

2. The mail transit system of claim 1, wherein the cloud transit device includes a transformation program so as to transform the mail message.

3. The mail transit system of claim 2, wherein the cloud transit device includes a storing module for storing the transformation program.

4. The mail transit system of claim 1, wherein the cloud transit device includes a transmitting module for receiving and transmitting the mail message between the first mail box interface and the second mail box interface.

5. The mail transit system of claim 1, wherein the sending-end device includes a temporary storage module storing the mail message so as to provide the user to select the mail message stored in the temporary storage module to perform a correction process.

6. A mail recycling correction method, comprising the following steps:
utilizing a sending-end device to provide a user to send a mail message via a first mail box interface;
receiving the mail message and transforming an address of the mail message by a cloud transit device;
utilizing the cloud transit device to transmit the transformed mail message to a second mail box interface, wherein the first mail box interface is different from the second mail box interface;
utilizing the sending-end device to provide the user to amend the mail message and send a correction command to the cloud transit device when the mail message in the second mail box interface is in an unread state; and
recycling or amending the mail message at the second mail box interface by the cloud transit device.

7. The mail recycling correction method of claim 6, wherein the cloud transit device includes a transformation program for performing the step of transforming the address of the mail message.

8. The mail recycling correction method of claim 7, the method further comprising the following step:
storing the transformation program by a storing module of the cloud transit device.

9. The mail recycling correction method of claim 6, wherein the cloud transit device receives and transmits the mail message between the first mail box interface and the second mail box interface by a transmitting module.

10. The mail recycling correction method of claim 6, further comprising the following step:
utilizing a temporary storage module of the sending-end device to store the mail message so as to provide the user to select the mail message stored in the temporary storage module to perform a correction process.
